(19) United States
(12) Patent Application Publication
(10) Pub. No.: US 2015/0166294 A1
(43) Pub. Date: Jun. 18, 2015

(54) DEVICE FOR PROCESSING A WEB OF PACKAGING MATERIAL

(71) Applicant: GDM S.P.A., Bologna (IT)

(72) Inventors: Alberto Perego, Milano (IT); Matteo Piantoni, Albino (Bergamo) (IT)

(73) Assignee: GDM S.p.A, Bologna (IT)

(21) Appl. No.: 14/414,561

(22) PCT Filed: Jul. 15, 2013
(86) PCT No.: PCT/IB2013/055826

§ 371 Date: Jan. 13, 2015

(30) Foreign Application Priority Data
Jul. 27, 2012 (IT) BO2012A000407

(51) Int. Cl. B65H 35/08; B65G 47/32; B26D 7/32; B65G 47/244

(52) U.S. Cl. CPC B65H 35/08; B65G 47/244; B65G 47/32; B26D 7/32

(57) ABSTRACT

A device for processing a web of material for making nappies includes a rotary shaft having a first axis, a plurality of pads for receiving and holding the web. The pads are rotatable about the first axis and are movable relative to the first axis during operation. A plurality of anvils, each interposed between two consecutive pads, are connected with the rotary shaft and are rotatable with it about the first axis. A unit acting in conjunction with the anvils cuts the web into lengths. A first motor is mounted inside the device and connected to the pads to translate the pads along a radial direction at right angles to the first axis and a second motor is mounted inside the device and connected to the pads to rotate the pads about a second axis coinciding with the radial direction.

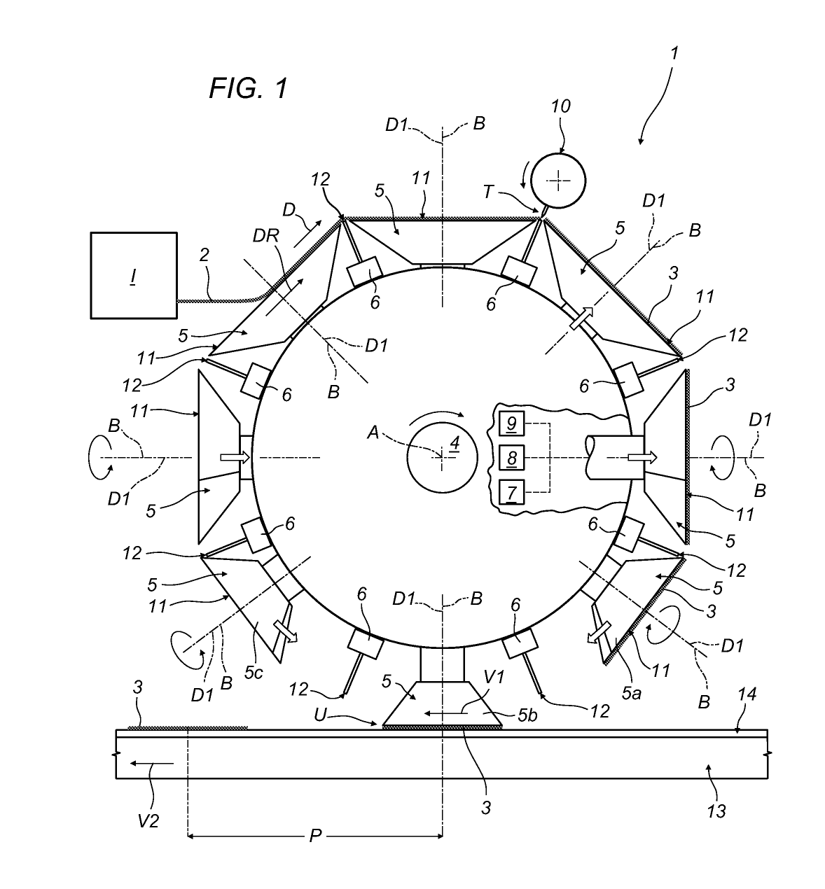

### TECHNICAL FIELD

This invention relates to a device for processing a web of packaging material,

More specifically, the device addresses the field of processing a continuous web of elasticized material used to make the elasticized waistbands of nappies for children or adults.

More precisely, the invention relates to a device which cuts the continuous web into lengths constituting the elasticized waistbands, which are suitably oriented before being applied, on leaving the device, to a continuous row of nappies being made up.

### BACKGROUND ART

Prior art devices of this kind comprise a drum which rotates about an axis and which mounts pads for receiving and holding down the continuous web, and a cutter for cutting the web into individual lengths.

To be able to orient each length correctly before it is released to the conveyor belt, the pads are able to rotate about an axis at right angles to the axis of rotation of the drum.

The device is also equipped with a plurality of anvils, interposed between the pads, which act in conjunction with the cutter during cutting.

For the cut to be made correctly, two consecutive pads must define as smooth a surface as possible for the web to lie and be held down on and, at the moment of cutting, the anvil must be positioned at this surface, which the web is lying on.

For this reason, during cutting, the anvil comes very close to each of the pads adjacent to it.

This creates the risk of impact between pad and anvil when the pad starts rotating in order to orientate the length of web before releasing it.

Although machines able to overcome this problem are known in the prior art, these machines have very complex structures and are also very complex in kinematic terms because precise coordination is required between the movement effected by the pads and a further movement effected by the anvils.

### DISCLOSURE OF THE INVENTION

This invention has for an aim to provide a device for processing a web of packaging material which overcomes the above mentioned drawback of the prior art.

More specifically, the primary aim of the invention is to provide a device for processing a web of packaging material which is simplified in structure and kinematic coordination between pads and anvils.

In accordance with the invention, this aim is achieved by a device for processing a web of packaging material comprising the technical features described in the independent claim 1.

The secondary claims define other advantageous aspects of the invention.

### BRIEF DESCRIPTION OF DRAWING

This and other innovative features of the invention, as well as the advantages thereby achieved, will become more apparent from the following description of a preferred, non-limiting example embodiment of it, with reference to the accompanying drawing which is a side view, with some parts cut away in order to better illustrate others, of a device according to the invention.

### DETAILED DESCRIPTION OF THE PREFERRED EMBODIMENTS OF THE INVENTION

The numeral 1 in the accompanying drawing denotes in its entirety a device for processing a web of packaging material according to this invention.

The device 1 receives from a feed station, located at the infeed to the device 1 and labelled I, a continuous web 2 of elasticized material, which is handled and then fed out to a conveyor, labelled 13 in the drawing, at a release station U.

More specifically, the device 1 cuts the web 2 into lengths 3 and the lengths 3 are then released to the conveyor 13 with a predetermined and desired orientation.

Preferably, the conveyor 13 is a conveyor belt, which is illustrated only in part in the drawing, for feeding at a speed v2 a continuous row 14 of nappies being made up. After being applied to the nappies, the lengths 3 of web 2 constitute the elasticized waistbands of the nappies.

The lengths 3 of elasticized web 2 must be applied in the same position to each nappy in the row 14 and for this reason, the lengths 3 must be released onto the row 14 at a predetermined, set spacing p.

More specifically, the spacing p varies in accordance with the size and type of nappy to be made and with the feed speed v2 of the row 14 of nappies.

As will become clearer as this description continues, the device 1 according to the invention releases the lengths 3 to the conveyor 13 and in so doing adjusts to the speed v2 and to the required spacing p at the outfeed of the selfsame conveyor 13.

Looking in more detail, the device 1 comprises a rotary shaft 4 which defines an axis of rotation A of the device 1.

The web 2 and the lengths 3 advance from the feed station I to the release station U along a direction labelled D. More specifically, since the device 1 is rotatable about a first axis A, the direction D is the direction imparted to the web 2 and to the lengths 3 as they advance, which is tangent at any point to the circular path followed by the selfsame web 2 and lengths 3 from the feed station I to the release station U. Thus, as explained in more detail below, the expression “predetermined, defined orientation” of the lengths 3 when they are released to the conveyor 13 means the orientation they adopt relative to the feed direction D as just defined.

The device 1 comprises a plurality of pads 5, rotatable about the first axis A, for receiving and holding down the web 2 and the lengths 3 as they travel from the feed station I to the release station U.

The device 1 also comprises a plurality of anvils 6, also rotatable about the first axis A and, as shown in the drawing, each of which is interposed between two consecutive pads 5.

The device 1 further comprises a cutting unit 10, preferably comprising a rotating roller which is equipped with one or more cutters and which acts in conjunction with the anvils 6 in order to cut the web 2 into lengths 3 at a cutting station, labelled T.

After being cut, each length 3 is held down by a respective pad 5 until it is released at the release station U.

More specifically, in a preferred embodiment, the anvils 6 are mounted as one with a wheel, the wheel being in turn mounted as one with the rotary shaft 4. Thus, the anvils 6 are rotatable as one with the shaft 4 about the first axis A.

The pads 5 are also connected to the shaft 4 to rotate with them about the first axis A. However, to be able to release the lengths 3 to the conveyor 13 with the predetermined orientation and to be able to adjust to the speed v2 and spacing p required by the conveyor 13, the pads 5 are movable relative to the shaft 4 as it rotates about the first axis A.

In other words, during the operation of the device 1, the anvils 6 remain in a fixed position relative to, and at a fixed distance from, the shaft 4 and the first axis of rotation A, whilst the pads 5 can vary their position in terms of distance from the first axis A and orientation relative to a direction at right angles to the first axis A, and to vary their feed speed, labelled v1 in the drawing.

The pads 5 are first of all capable of translation along a radial direction DI at right angles to the first axis of rotation A.

The translation of the pads 5 occurs by the action of first motor means, schematically represented by the block 7 in the drawing, connected to each of the pads 5 and mounted inside the device 1. In the preferred embodiment, translation is achieved through a first cam system, not illustrated because it is of a kind well known to experts in the trade, and which comprises a first cam integral with a fixed frame (not illustrated) for referencing the device 1 and a plurality of roller tappets, which roil on the cams and each of which is connected to a respective pad 5.

As stated above, the lengths 3 are released to the conveyor 13 with a predetermined, desired orientation.

To obtain the desired orientation, the pads 5 can rotate about a second axis B, which coincides with the radial direction D1.

The rotation of the lengths 3 is achieved through second motor means, schematically represented by the block 8 in the drawing, also connected to the pads 5 and mounted inside the device 1 and comprising a second cam system similar to the first and also not illustrated because it is of a kind well known to experts in the trade.

Further, when it releases the lengths 3 to the conveyor 13, the device 1 adapts to the outfeed speed v2 required by the conveyor 13 itself.

In other words, the device 1 can suitably increase or decrease the peripheral feed speed v1 of each pad 5 during rotation about the first axis A, in order to adapt to the outfeed speed v2 required and set by the conveyor 13.

This adjustment and adaptation of the speed v1 is obtained by connecting the pads 5 to third motor means, schematically represented by the block 9 in the drawing and also mounted inside the device 1. Like the first motor means 7 and the second motor means 8, the third motor means 9 comprise a third cam system, similar to the ones mentioned above and thus not illustrated because it too is of a kind well known to experts in the trade.

It should be noted that the third motor means 9 allow each pad 5 to move in the space separating two consecutive anvils 6 according to a law of motion whereby each pad 5 moves from one end position close to one anvil 6 to another end position close to the other, passing by a plurality of positions intermediate between the two end ones.

In other words, each pad 3 can swing between said two end positions, where it is alternately close to the anvil 6 preceding it and the one following it according to the direction of rotation about the axis A, and can reach infinite intermediate positions included in the space between the two end positions.

The third motor means 9 cause the pad 5 to swing about the first axis of rotation A between a first position upstream of the station U, where the pad 5 is located with its axis of rotation B close to the rear anvil 6, which is behind in the feed direction of the pad 5 itself, and a second position downstream of the station U, where the pad 5 is located with its axis of rotation B close to the adjacent anvil 6, which is in front in the feed direction of the pad 5 itself.

in other words, while the pads 5 are rotating about the first axis of rotation A, the third motor means 9 cause each of them to also rotate or swing from a position where it is close to the rear anvil 6 to a position where it is close to the front anvil 6.

This further movement of each pad 5 starts, as stated above, before reaching the release station U and ends after passing the station.

Thus, from the first position to the second, the speed v1 of each pad 5 is suitably increased by action of the third motor means 9 in such a way that when the length 3 is released at the release station U, it reaches a speed equal to the required speed v2 of the conveyor belt 13.

The adoption of respective cam systems to define the aforementioned first 7, second 8 and third 9 motor means is particularly advantageous because they constitute a constructionally simple solution to accomplish all the above described movements of each of the pads 5. Also, the cam systems make it possible to simplify implementing the laws of motion needed to correctly coordinate all the movements of the pad 5. The above mentioned cam systems allow the movements of the pads 5 to be carried out sequentially, one after the other, or in such a way that two or all three of the movements are simultaneous.

Furthermore, the adjustment and adaptation of the feed speed v1 of the pads 5 according to the feed speed v2 of the conveyor 13 is also obtained by the aforementioned translation of the pads 5 along the radial direction D1. More specifically, reference is made to the translation of the pads 5 during their movement away from the shaft 4 and from the first axis of rotation A, which, as will become dearer below, occurs between the station T of cutting and the station U of releasing the length 3.

In effect, a longer excursion of the pads 5 allows the peripheral speed v1 to be increased because it increases the distance from the first axis of rotation A, which lets the device 1 reach the required speed v2 more effectively and with more gradual acceleration, at the release station U.

The aforementioned translation of the pads 5 also allows the lengths 3 to be released onto the conveyor 13 more precisely according to the required spacing p.

In effect, the greater distance from the first axis of rotation A means also increasing the spacing p, in this case circumferential, between the two consecutive pads 5

Thus, thanks to the first motor means 7 and the third motor means 9, the device 1 can release the lengths 3 onto the conveyor 13 with great precision according to the values of speed v2 and spacing p required at outfeed, based, for example on the type of nappy to be made.

Further, each of the pads 5 has a top face which comes into contact with the continuous web 2 at the feed station

More precisely, the face defines a contact and hold-down surface 11 for the web 2 and the lengths 3 as they are transferred from the feed station I to the conveyor belt 13.

The surface 11 is provided with a plurality of suction holes, not illustrated, connected to a vacuum source (not illustrated) by which the web 2 and the lengths 3 are held down.

The anvils 6 also define respective surfaces, labelled 12 in the drawing, which act as counter-blades for the cutters of the cutting unit 10 during the cutting of the web 2 into lengths 3.

To enable the web 2 to be cut precisely at the station T, each pad 5, or more specifically its hold-down surface 11, before reaching the cutting station T, is aligned and made substantially co-planar with the contact surfaces 12 of the anvils 6 adjacent to the pad 5.

More precisely, the co-planarity of the surfaces 11 and 12 allows the web 2 to lie on as smooth and uniform a surface as possible, without irregularities or unevenness which might cause a bad or imprecise cut when it reaches the cutting station T.

To further increase the smoothness and uniformity of the surface, the pads 5 are oriented in such a way that a reference direction for the pads 5, labelled DR in the drawing, is aligned with the feed direction 0 of the web 2.

Preferably, the face of each pad 5 defining the contact surface 11, has a substantially elongate shape and hence, the reference direction DR is the direction which coincides with the main direction of extension of that face,

It should be noted that other directions or axes of the pad 5 might be used as references to indicate the pad orientation, in particular at the feed station I and at the release station U.

It is therefore preferable for the pads 5 to be orientated with their respective hold-down surfaces 11 aligned with the contact surfaces 12 of the anvils 6, at least from the feed station I to the cutting station T, in such a way as to afford as large a surface as possible for holding down the web 2, thus providing a better grip on the web 2 and preventing it from becoming misaligned before it reaches the station T.

Between the feed station I and the cutting station T, the hold-down surface 11 of the respective pad 5 is also at a reduced distance from the contact surfaces 12 of the anvils 6 adjacent to the pad 5 itself. Indeed, as clearly shown in the drawing, it may be noted that, between the feed station I and the cutting station T. the hold-down surfaces 11 of the pads 5 are extremely close to the contact surfaces 12 of the anvils 6. As stated above, this improves the smoothness and uniformity of the surface the web 2 lies on, defined by the surfaces 11 of the pads 5 and the surfaces 12 of the anvils 6, thus ensuring a correct and better cut.

According to what has been described up to now, possible to identify two main operating configurations which the pads 5 can adopt.

In a first operating configuration, for receiving and holding the web 2 at the feed station I, the pad 5 is orientated in such a way that its reference direction DR is aligned with the feed direction D of the web 2 and the respective contact and hold-down surface 11 is aligned and co-planar with the contact surfaces 12 of the anvils 6 adjacent to the selfsame pad 5.

In a second operating configuration, on the other hand, for releasing the length 3 of web 2 to the conveyor 13 at the station U. the pad 5 is orientated in such a way that its reference direction DR makes with the feed direction D a predefined angle of orientation of the lengths 3, and the respective contact and hold-down surface 11 is away from the first axis of rotation A and from the contact surfaces 12 of the anvils 6 adjacent to the pad 5.

During operation, therefore, there is relative movement between the pads 5 and the anvils 6, although only the pads 5 are moved.

The web 2 is held down by the vacuum source which is placed in communication with the holes on the contact surfaces 11 of the pads 5 between the feed station I and the release station U.

More specifically, in the preferred embodiment, the device 1 comprises an intake cam (not illustrated) fixed to the above mentioned frame of the device 1 and connected to the vacuum source, and a valve element preferably made in the form of a disc (not illustrated) which is provided with holes or openings and which is mounted on the shaft 4 so as to rotate as one therewith about the first axis A. Each of the holes in the disc is connected via one or more conduits (not illustrated) to the holes on the contact and hold-down surface 11 of a respective pad 5.

More specifically, each pad 5 is connected to a further valve element, also not illustrated, which is hollow and provided with one or more inlet ports, each of which can be connected to one of the conduits, and one or more outlet ports, which, instead, are in fluid communication with the holes on the contact surface 11.

Each of the conduits is fixed, and during operation of the device 1, has a respective inlet port which is permanently connected to a respective hole in the disc and, hence, to the vacuum source, and an outlet port which is aligned with a respective inlet port of the hollow valve element only between the feed station I and the release station U.

The hollow valve element preferably translates as one with the pad 5 but does not rotate as one with it. In other words, when the pad 5 moves towards the second operating configuration, the hollow valve element also moves away from the first axis of rotation A and its inlet ports are not aligned with the outlet ports of the conduits. That way, when the pad 5 reaches the second operating configuration at the release station U, connection with the vacuum source is interrupted and the length 3 can be released to the conveyor 13. As long as the pads 5 are at the first operating configuration, on the other hand, the outlet ports of the conduits are aligned with the respective inlet ports of the respective hollow valve element, allowing the web 2 to be kept adherent to the contact surface 11 of the pad 5 and ensuring that cutting can be performed correctly. When the pad 5 reaches the second operating configuration, the conduits can be placed in fluid connection with a source of air under pressure so as to facilitate detachment of the lengths 3 and their release to the conveyor 13.

In use, the continuous web 2 is fed in by the feed station I and immediately held down by the pads 5 through the agency of the suction holes. As stated previously, the pads 5 receive the continuous web 2 when they are at the first operating configuration.

Next, when the web 2 reaches the cutting station T, the cutting unit 10 cuts the web 2 into lengths 3 and the lengths 3 are held down by the pads 5 until the moment comes for them to be released. Before reaching the release station U, the pads 5 are rotated about the second axis B in such a way as to turn the lengths 3 to the orientation required for their release, Preferably, as shown in the drawing, the lengths 3 are turned through an angle of rotation of 90°.

Further, as explained above in connection with the proximity of the pads 5 to the anvils 6, if the pads 5 were turned immediately downstream of the cutting station T, the pads 5 would strike the anvils 6 adjacent to them.

Thus, before they are turned, the pads 5 are made to translate away from the first axis of rotation A and from the anvils 6 and only when they are at a predetermined distance away are they turned about the second axis B to reach the second operating configuration.

The pads 5 might be translated and simultaneously rotated or translation and/or rotation might be performed in two or more successive steps.

Thus, in order to prevent the pads 5 from impacting the adjacent anvils 6 during rotation, it is very important for the rotational and translational movements of each pad 5 to be adjusted in such a way that the different laws of motion are precisely coordinated. The use of the aforementioned cam systems makes it possible to correctly coordinate the laws of motion in a constructionally simple and at once effective manner,

In order to further facilitate their rotation and avoid them impacting the anvils 6, in the preferred embodiment illustrated, the pads 5 are substantially in the shape of a truncated pyramid where the large base defines the contact and hold-down surface 11, the small base, parallel with and opposite the large base, is connected to the first 7, second 8 and third 9 motor means, whilst each inclined lateral surface faces a respective anvil 6 adjacent to the pad 5, Further, the contact and hold-down surface 11 is substantially rectangular in shape and the reference direction DR coincides with the main direction of extension of the rectangle.

In a variant embodiment not illustrated, on the other hand, each pad 5 is in the form of a plate where, in this case, too, the contact and hold-down surface 11 is substantially rectangular in shape.

Both of these embodiments maximize the surface area available for holding down the web 2 without the risk of impacting the adjacent anvils 6, because during the rotation of the pad 5, these shapes prevent contact between the material body constituting the pad 5 and the anvils 6.

Obviously, pads 5 and contact and hold-down surfaces 11 in shapes and forms other than those just described are also admissible without departing from the scope of the inventive concept.

After reaching the second operating configuration or while reaching it, the device 1 adjusts the feed speed v1 of the pads 5 according to the outfeed speed v2 and spacing p required by the conveyor 13.

As mentioned above, the third motor means 9 slow down and then accelerate the feed speed v1 of each pad 5 by causing it to swing between a first position upstream of the station U and a second position downstream of the station U.

This swinging motion causes the speed v1 of the pad 5 to increase until. at the moment the length 3 is released, it reaches a value equal to the value of the feed speed v2 of the conveyor 13.

Slowing down the speed v1 of the pad 5 prior to acceleration guarantees that the speed v2 is reached without subjecting the length 3 to stresses due to sudden acceleration which would cause it to become detached from the pad 5.

After the length 3 is released, the inertia acquired by the pad 5 during acceleration is dampened by a deceleration and the pad 5 is brought back with its own axis of rotation B to a position and speed v1 such that it can receive the web 2 of elasticized material at the feed station I.

What has just been described is represented in the drawing by the positions adopted by the pads labelled 5a, 5b and 5c.

As already stated, before reaching the release station U, the pad 5 is slowed down, represented in the drawing by the pad 5a transporting a length 3 of material. In effect, the pad 5a is shown with its axis of rotation B very close to the anvil 6 behind it with reference to the feed direction D of the web 2.

In the drawing, the acceleration imparted to the pad 5a is indicated by a white arrow pointing in the same direction as the feed direction D.

The release position of the length 3 where the feed speed v1 of the pad is equal to the feed speed v2 of the conveyor 13, is represented by the pad 5b which, in effect, is at, and face to face with, the conveyor 13 for releasing the length 3.

Lastly, the pad 5c represents the position reached after the length 3 is released following the speed increase. In effect, the pad 5c is shown with its axis of rotation B very close to the anvil 6 in front of it, again with reference to the feed direction D, on account of the inertia acquired with acceleration.

The deceleration the pad 5c is subjected to in order to dampen the inertia acquired is indicated by the white arrow pointing in the direction opposite to the feed direction D of the web 2.

Lastly, before reaching the feed station I, the pad 5 is brought from the second operating configuration to the first operating configuration so it can receive the continuous web 2 again.

The invention described above is susceptible of industrial application and may be modified and adapted in several ways without thereby departing from the scope of the inventive concept. Moreover, all the details of the invention may be substituted for technically equivalent elements.

For example, the device 1, besides processing a continuous web of elasticized material from which are obtained the lengths which are suitably orientated and then applied to the nappies to make the elasticized waistbands of the nappies, might pick up and transfer a continuous web of nappy material in the same way as described above with reference to the lengths 3 of elasticized material.

More specifically, starting from receiving a continuous web of complete nappy material, the device can cut the web into lengths, each constituting a nappy, transfer and rotate them according to the operating steps described above for the lengths 3 and then apply each nappy length to two continuous strips of elasticized material advancing on the conveyor 13.

The strips are then cut to size to obtain a series of finished nappies.

1. A device for processing a web of packaging material, comprising:
a rotary shaft defining a first axis of rotation;
a plurality of pads for receiving and holding down the web to be handled from a feed station, at the infeed of the device, to a conveyor at a release station at the outfeed of the device, the pads being rotatable about the first axis and being movable relative to it during operation;
a plurality of anvils connected as one with the shaft and rotatable with it about the first axis during operation, each anvil being interposed between two consecutive pads;
a unit acting in conjunction with the anvils to cut the web into lengths;
first motor means, mounted inside the device and connected to the pads to translate the pads along a radial direction at right angles to the first axis:
second motor means, mounted inside the device and connected to the pads to rotate the pads about a second axis coinciding with the radial direction.

2. The device according to claim 1, wherein each of the pads has a respective contact surface for holding down the web and the lengths and each of the anvils has a respective contact surface acting in conjunction with the cutting unit while the web is being cut, the pads being movable between a first operating configuration for receiving and holding down the web at the feed station, where the respective contact and hold-down surface has a reference direction which is aligned with a feed direction of the web and the contact and hold-down surface is aligned and co-planar with the contact surfaces of the respective anvils adjacent to the pad, and a second operating configuration for releasing the length at the release station, where the reference direction of a respective pad forms a predefined angle with the feed direction and the hold-down surface is away from the contact surface of the anvil.

3. The device according to claim 1, wherein it comprises third motor means, mounted inside the device and connected to each pad to vary the peripheral feed speed of the pad so as to transfer the lengths to the conveyor at a spacing and at a feed speed equal to a speed value set by the selfsame conveyor.

4. The device according to claim , wherein each pad can swing between two end positions where it is alternately close to the anvil preceding it and the one following it according to the direction of rotation about the axis.

5. The device according to claim 1, wherein each pad can swing between two end positions where it is alternately close to the anvil preceding it and the one following it according to the direction of rotation about the axis and can reach infinite intermediate positions included in the space between the two end positions.
